(19) United States
(12) Patent Application Publication
(10) Pub. No.: US 2015/0106663 A1
(43) Pub. Date: Apr. 16, 2015

(54) HASH LABELING OF LOGGING MESSAGES

(71) Applicant: SAS Institute Inc., Cary, NC (US)

(72) Inventor: Andrew H. Richter, Cary, NC (US)

(73) Assignee: SAS Institute Inc., Cary, NC (US)

(21) Appl. No.: 14/209,476

(22) Filed: Mar. 13, 2014

Related U.S. Application Data
(60) Provisional application No. 61/890,911, filed on Oct. 15, 2013.

(51) Int. Cl. G06F 11/34; H04L 9/06; G06F 11/36

(52) U.S. Cl. CPC G06F 11/3476; G06F 11/3636; H04L 9/0643; G06F 2201/80; G06F 2201/865
USPC 714/45; 707/698

(57) ABSTRACT

Systems and methods for labeling text with alphanumeric identifiers are included. A logging string that includes a block of output text may be determined during program code execution. A computing device may generate a first alphanumeric identifier for the logging string using a hashing algorithm. The computing device may remove a portion of the logging string to determine a modified string. The computing device may generate a second alphanumeric identifier for the modified string using the hashing algorithm. The first alphanumeric identifier and the second alphanumeric identifier are presented with the logging string.

### CROSS-REFERENCE TO RELATED APPLICATIONS

The present disclosure claims the benefit of priority of 35 U.S.C. §119(e) to U.S. Provisional Application No. 61/890,911, filed Oct. 15, 2013 and titled “MD5 Hash Labeling of Java Exception Messages,” the entirety of which is incorporated herein by reference.

### TECHNICAL FIELD

The present disclosure generally relates to computer-implemented systems and methods for labeling exception messages.

### BACKGROUND

Logging statements that are output during program code execution can be lengthy. Thus, identifying particular logging statements in a log file can be time-consuming and frustrating for the user.

### SUMMARY

In accordance with the teachings provided herein, systems and methods for hash labeling logging messages are provided.

For example, a computer-program product tangibly embodied in a non-transitory machine-readable storage medium is provided that includes instructions that can cause a data processing apparatus to obtain a logging string that includes a block of output text determined during execution of program code. A first alphanumeric identifier for the logging string is generated by a computing system using a hashing algorithm. The computing system removes a portion of the logging string to determine a modified string. A second alphanumeric identifier is generated for the modified string by the computing system using the hashing algorithm. The first alphanumeric identifier and the second alphanumeric identifier are presented with the logging string.

In another example, a computer-implemented method is provided that includes obtaining a logging string that includes a block of output text determined during execution of program code. A first alphanumeric identifier for the logging string is generated by a computing system using a hashing algorithm. The computing system removes a portion of the logging string to determine a modified string. A second alphanumeric identifier is generated for the modified string by the computing system using the hashing algorithm. The first alphanumeric identifier and the second alphanumeric identifier are presented with the logging string.

In another example, a system is provided that includes a processor and a non-transitory computer readable storage medium containing instructions that, when executed on the processor, cause the processor to perform operations. The operations include obtaining a logging string that includes a block of output text determined during execution of program code. A first alphanumeric identifier for the logging string is generated by a computing system using a hashing algorithm. The computing system removes a portion of the logging string to determine a modified string. A second alphanumeric identifier is generated for the modified string by the computing system using the hashing algorithm. The first alphanumeric identifier and the second alphanumeric identifier are presented with the logging string.

The details of one or more embodiments are set forth in the accompanying drawings and the description below. Other features and aspects will become apparent from the description, the drawings, and the claims.

### BRIEF DESCRIPTION OF THE DRAWINGS

FIG. 1 shows a block diagram of an example of a computer-implemented environment for generating alphanumeric hashing identifiers that identify text generated during program code execution.

FIG. 2 shows a block diagram of example hardware for a computer architecture used to generate alphanumeric hashing identifiers for text generated during program code execution.

FIG. 3 shows an example flow diagram for generating hashing identifiers.

FIG. 4 shows an example logging output including a first hash identifier and a second hash identifier presented with a stack trace.

FIG. 5 shows an example of a stack trace produced during program execution.

FIG. 6 shows an example flow diagram for detecting an event during program execution that results in the generation of hashing identifiers.

FIG. 7 shows an example process for generating hashing identifiers using an MD5 hashing algorithm.

FIG. 8 shows an example environment for searching an error database utilizing a hash identifier.

Like reference numbers and designations in the various drawings may indicate like elements.

### DETAILED DESCRIPTION

Aspects of the disclosed subject matter relate to techniques for using hashing algorithms to generate labels for text produced during program code execution. For example, an MD5 hashing algorithm can be used to generate identifiers used to label an exception message produced during Java™ code execution. In one example, a method can include creating a hash identifier of a stack trace. A stack trace is text containing at least one each of a filename, a function call, and a line number. The stack trace can be used as input into a hashing algorithm to create a “tight” match hash identifier. A stack trace may be modified to remove any or all filenames or line numbers. This modified stack track may be used as input into a hashing algorithm, creating a “loose” match hash identifier. As an example, a software engineer may utilize the tight or loose match identifiers to identify particular errors in code or a particular type of error in code, thus making it easier to debug, support, and maintain program code. The software engineer may use a hash identifier to conduct a search in a log file or, alternatively, an error database to identify problem patterns in the program code.

In one example, a java programmer may desire to create a unique label to identify a specific error, or type of error, in program code. When an error has occurred in Java™, for example, a stack trace may be generated before the process is ended. The stack trace can indicate a sequence of function calls that preceded the error. The programmer can use the stack trace to trace back in code to the source of the error. The programmer may use the stack trace as search input when conducting a search for errors within an error database. Line numbers may change as code is added during the course of development. Similarly, function calls contained in separate areas of code may have different line numbers but produce similar errors. Thus, a search using the original stack trace may return no results.

A programmer may face a similar dilemma if an exception is thrown. An exception can represent one way in Java™ to indicate to a calling method that an abnormal condition has occurred. A programmer may encapsulate program code in a “try” block. The programmer may then define what should happen if an error occurs in the encapsulated code by defining a “catch” block. Upon program execution, the method may try to execute the code encapsulated in the “try” block. In one example, the programmer may have a typographical error that introduces an error. An exception may be thrown when the method encounters this abnormal condition. The code encapsulated in the “catch” block may then be executed. For example, the following try/catch block may be used.

```
try
{
  FileReader fileReader = new FileReader(“fred.txt”);
  BufferedReader bufferedReader = new BufferedReader(fileReader);
  while((line = bufferedReader.readLine( )) != null)
  {
    System.out.println(line);
  }
}
catch (IOException e)
{
    System.out.println(“Got an IOException: ” e.getMessage( ));
}
```

In this example, the text “10 Exception Found” will be output to a log file when the code contained in the “try” block is executed. The getMessage( ) method call may execute a method known as printStackTrack( ) that may output the following stack trace:

java.io.FileNotFoundException: fred.txt

at java.io.FileInputStream.<init>(FileInputStream.java)
at java.io.FileInputStream.<init>(FileInputStream.java)
at Test.readFile(Test.java:59)
at Test.main(Test.java:7)

Instead of using the stack trace function call in the above examples, the printStackTrace( ) routine can be replaced with a method that determines “tight” and “loose” match hash identifiers to be presented along with the stack trace. The result may be a printout that resembles the following:

```
java.io.FileNotFoundException: fred.txt
Tight MD5: 5cb24f2b575534d68bf3069dbf423f9d
  Loose MD5: c47922db6e59c029d4e9d2d06747befa
    at java.io.FileInputStream.<init>(FileInputStream.java)
      at java.io.FileInputStream.<init>(FileInputStream.java)
      at Test.readFile(Test.java:59)
      at Test.main(Test.java:7)
```

In the above example, the addition of the MD5 tight and loose checksums can allow a unique label for each error. Stack traces can be hundreds of lines long or more. Searching for errors can be very time-consuming. If the same error occurs in two versions of the same Java™ code, then a search can result in a failure because an exact match may not be found. In some cases, a false positive may be found if some of the code is the same but the stack trace patterns are different.

The stack trace patterns can relate to multiple versions of code. As code is developed, function call line numbers can change. For example, a failure that happened in a first software version on line 1245 may be on line 1364 in the next software version. The Java™ stack trace generated from a failure may be identical between software versions except for the line numbers. The pattern of the calls can remain the same. A “loose” MD5 checksum may be used to identify stack traces that share identical function call sequences irrespective of line numbers associated with each function call. For example, the loose checksum can ignore line numbers, and can return the same checksum for two versions of code that have the same call pattern (e.g., a calls j calls k calls l . . . ).

The loose and tight match MD5 checksums can be for the same event. The loose checksum can be calculated by omitting the line numbers. The tight MD5 checksum can be calculated on the whole stack trace text. A subsequent search on an error database using the loose checksum would return a match if the call sequence of the text is identical to the call sequence of the stack trace. The loose match would match on a function call sequence without regard for line numbers. The tight and loose matches would both get a match for text that is identical to the stack trace text.

Though the above example utilizes a MD5 hashing algorithm, any hashing algorithm that generates minimal collisions including, but not limited to SHA-1, SHA-2, or SHA-3, for example, may be utilized in a similar manner to produce tight and loose checksums.

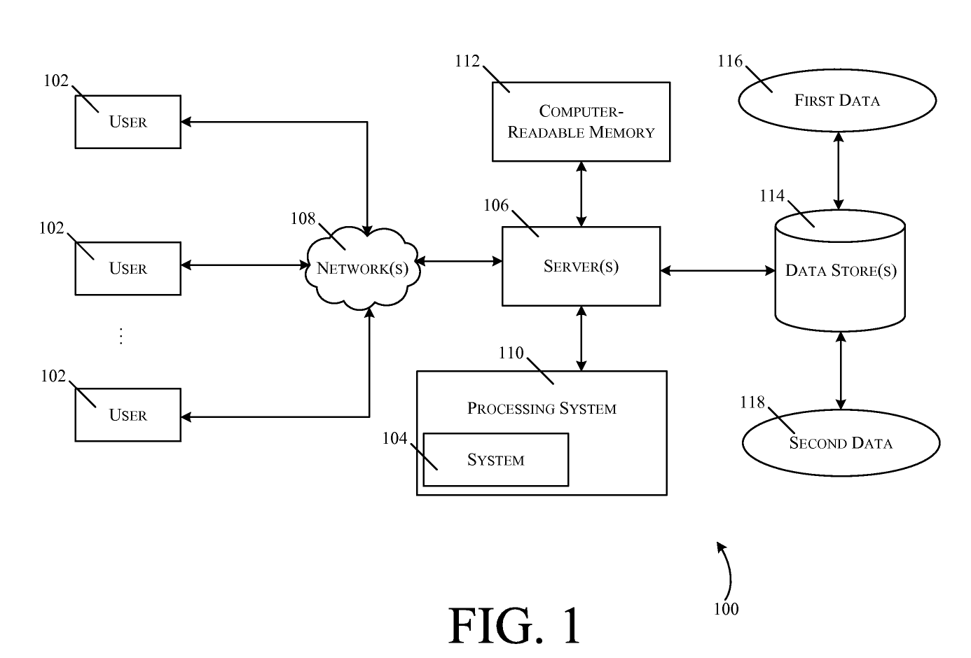

FIG. 1 shows a block diagram of an example of a computer-implemented environment 100 for generating alphanumeric hashing identifiers that identify text generated during program code execution. Users 102 can interact with a system 104 hosted on one or more servers 106 through one or more networks 108. The system 104 can contain software operations or routines. The users 102 can interact with the system 104 through a number of ways, such as over networks 108. Servers 106, accessible through the networks 108, can host system 104. The system 104 can also be provided on a stand-alone computer for access by a user.

In one example, the environment 100 may include a stand-alone computer architecture where a processing system 110 (e.g., one or more computer processors) includes the system 104 being executed on it. The processing system 110 has access to a computer-readable memory 112 in addition to one or more data stores 114. The data stores 114 may contain first data 116 as well as second data 118.

In one example, the environment 100 may include a client-server architecture. Users 102 may utilize a PC to access servers 106 running a system 104 on a processing system 110 via networks 108. The servers 106 may access a computer-readable memory 112 as well as data stores 114. The data stores 114 may contain first data 116 as well as second data 118.

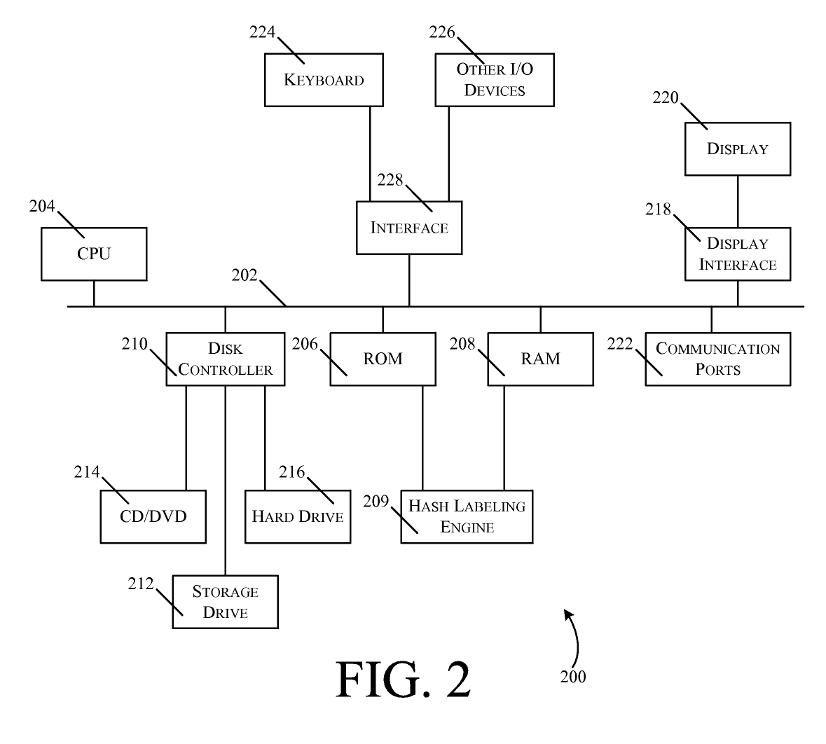

FIG. 2 shows a block diagram of example hardware for a computer architecture 200 used to generate alphanumeric hashing identifiers for text generated during program code execution. A bus 202 may interconnect the other illustrated components of the hardware. A processing system 204 labeled CPU (central processing unit) (e.g., one or more computer processors) may perform calculations and logic operations used to execute a program. A processor-readable storage medium, such as read-only memory (ROM) 206 and random access memory (RAM) 208, may be in communication with the processing system 204 and may contain one or more programming instructions. Optionally, program instructions may be stored on a computer-readable storage medium, such as a magnetic disk, optical disk, recordable memory device, flash memory, or other physical storage medium. Computer instructions may also be communicated via a communications transmission, data stream, or a modulated carrier wave. In one example, program instructions implementing hash labeling engine 209, as described further in this description, may be stored on storage drive 212, hard drive 216, read only memory (ROM) 206, random access memory (RAM) 208, or may exist as a stand-alone service external to the stand-alone computer architecture.

A disk controller 210 can interface one or more optional disk drives to the bus 202. These disk drives may be external or internal floppy disk drives such as storage drive 212, external or internal CD-ROM, CD-R, CD-RW, or DVD drives 214, or external or internal hard drive 216. As indicated previously, these various disk drives and disk controllers are optional devices.

A display interface 218 may permit information from the bus 202 to be displayed on a display 220 in audio, graphic, or alphanumeric format. Communication with external devices may optionally occur using various communication ports 222. In addition to the standard computer-type components, the hardware may also include data input devices, such as a keyboard 224, or other input devices 226 such as a microphone, remote control, touchpad, keypad, stylus, motion, or gesture sensor, location sensor, still or video camera, pointer, mouse or joystick, which can obtain information from bus 202 via interface 228.

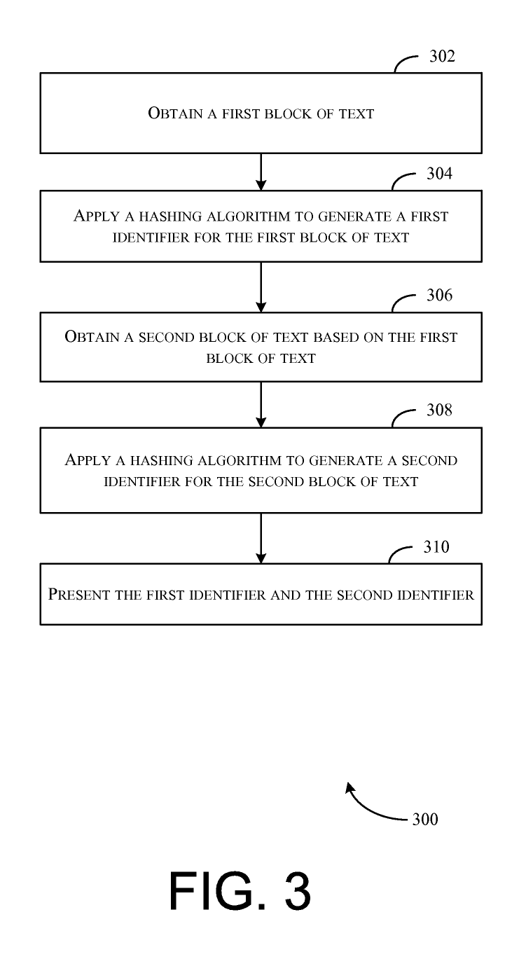

FIG. 3 shows an example flow diagram 300 for generating hashing identifiers. The flow diagram 300 can begin at block 302 at which a first block of text is obtained. The first block of text may be a stack trace. But any suitable logging output generated by a program written in any suitable programming language can be used as the first block of text.

At block 304, a hashing algorithm is applied to generate a first identifier for the first block of text. The first identifier may be an alphanumeric identifier of any suitable length. Alternatively, the first identifier may be entirely alphabetic or entirely numeric. The block of text may be input into the hashing algorithm to generate the first identifier. Any hashing algorithm that generates minimal collisions may be used including, but not limited to, an MD5 hashing algorithm, a SHA-1 hashing algorithm, a SHA-2 hashing algorithm, or a SHA-3 hashing algorithm. In one example, a “tight” checksum can be calculated on all of the text including the line numbers. Thus, a ‘tight” MD5 match indicates that the problem causing the stack trace is from the same sequence of events and likely the same code version—an exact match.

At block 306, a second block of text is obtained based on the first block of text. The second block of text may include some portion of the first block of text. For example, if the first block of text is:

at com.sas.solutions.profitability.common.core.operation.KeyLookups.-
lookupRepository(KeyLookups.java:333)

then the second block of text may be:

at com.sas.solutions.profitability.common.core.operation.KeyLookups.-
lookupRepository( )

as a result of the filename and line number being removed. Though the filename and line number are removed in this example, any portion of the first block of text may be removed to obtain the second block of text.

At block 308, a hashing algorithm is applied to generate a second identifier for the second block of text. The second identifier may be an alphanumeric identifier of any suitable length. Alternatively, the second identifier may be entirely alphabetic or entirely numeric. The block of text may be input into the hashing algorithm in order to generate the first identifier. Any hashing algorithm that generates minimal collisions may be used including, but not limited to, an MD5 hashing algorithm, a SHA-1 hashing algorithm, a SHA-2 algorithm, or a SHA-3 algorithm, for example. The hashing algorithm used to generate the second identifier may be the same, or different, algorithm used to generate the first identifier. In one example, a “tight” checksum can be calculated on all of the text including the line numbers. In one example, the second identifier may comprise a “loose” checksum. The “loose” checksum may be calculated on the stack trace without the Java™ line numbers. Program code that results in the same failure at a new location (e.g., a new line number) will use an identical text to generate the loose checksum as the text used to generate the loose checksum for the original program code. Specifically, the following text:

at com.sas.solutions.profitability.common.core.operation.KeyLookups.-
lookupRepository(KeyLookups.java:542)

would result in the same block of text, and consequently, the same “loose” checksum as:

at com.sas.solutions.profitability.common.core.operation.KeyLookups.-
lookupRepository(KeyLookups.java:333)

This would allow matches when the same problem is seen in several versions of java classes.

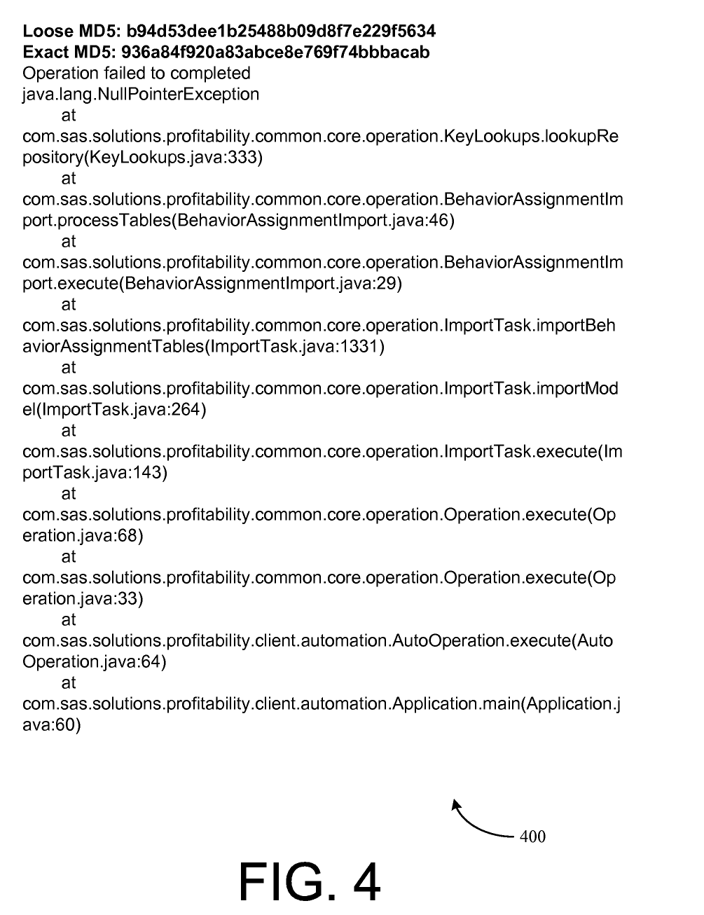

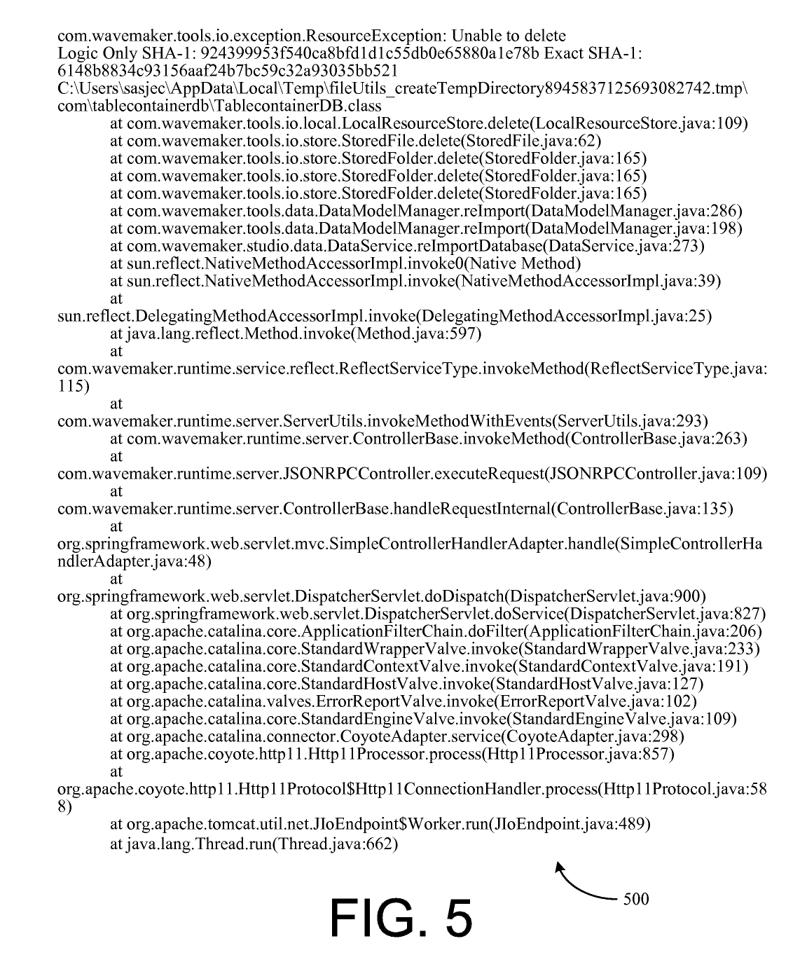

At block 310, the first identifier and the second identifier are presented. In one embodiment, the first identifier and the second identifier may be output to a log file such that both identifiers are displayed visually proximate to the stack track used to generate them. An example logging output 400 including a first hash identifier and a second hash identifier presented with a stack trace is shown in FIG. 4. An example stack trace 500 that may be used to determine the “loose” checksum is illustrated in FIG. 5. Additionally, or alternatively, the first identifier or the second identifier may be stored in a database for later use. The first identifier or the second identifier may be associated with additional information that concerns the stack trace used to generate the first identifier or the second identifier. The additional information includes, but is not limited to, a problem description or a resolution description, for example.

In another example, the pair of identifiers can be added to each java trace back, where both identifiers are MD5 sums of the text. This can allow a customer, a tech support person, a developer, or a tester to do a search that turns up a match for the trace back without having to edit out parts of the search strings.

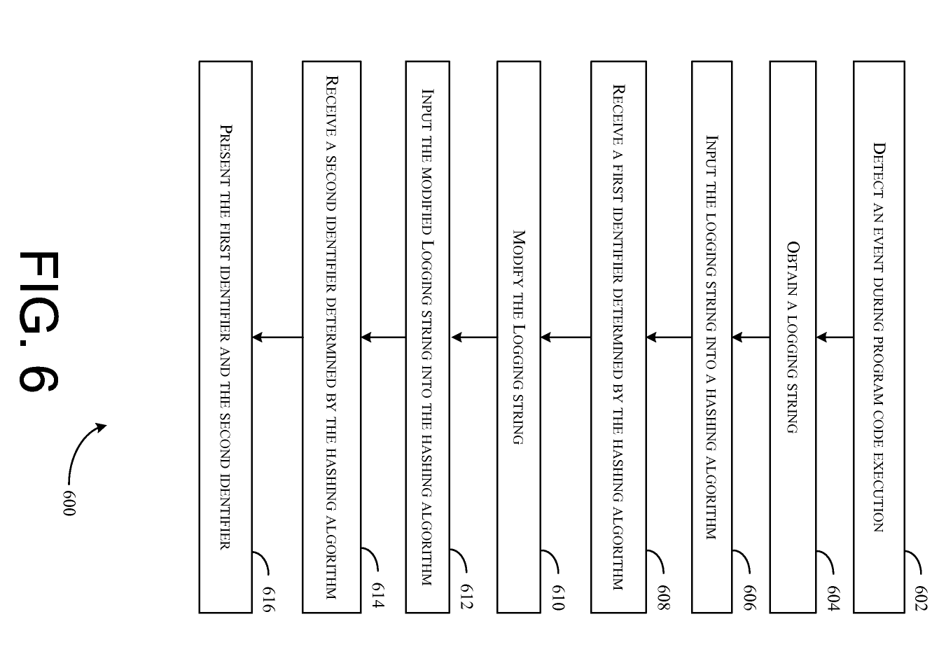

FIG. 6 shows an example flow diagram 600 for detecting an event during program execution that results in the generation of hashing identifiers. The flow diagram 600 begins at block 602, where an event is detected during program code execution. The event may indicate an error in program code. The event may occur at program execution time. The program may be written in any suitable programming language.

At block 604, a logging string is obtained. In one example, the logging string may be obtained as a result of the detection of the error at block 602. The logging string may be any suitable output. For example, a standard output string with a corresponding string length of one or more may be obtained as the logging string. Obtaining the logging string may include receiving the logging string as part of a function call pass. Additionally, or alternatively, the logging string may be determined by calling a separate function or method.

At block 606, the logging string is used as input in a hashing algorithm. In one example, the entire logging string may be used as input. In another example, the logging string may be truncated or may have string characters added. For example, a hashing algorithm may only accept a string of a particular length. Before inputting the logging string into the hashing algorithm, the logging string may be truncated to that particular length.

At block 608, a first identifier is determined by the hashing algorithm. In one example, the hashing algorithm may divide the logging string into equal-length subparts. For example, a 32-bit logging string might be divided into 4 separate bytes. The numerical representation of each byte may be determined and the number used as a particular variable in the algorithm. For example, if the first byte included 00000010, then the number “2” (the numerical representation of 00000010) may be used as input for the first variable of the hashing algorithm. In this manner, the other variables may be determined and the algorithm fully executed. The first identifier returned may involve any suitable alphanumeric identifier of any suitable length.

At block 610, the logging string is modified. In one example, the logging string may be truncated by some amount. For example, the logging string may include only the first N original characters while the remaining characters in the original string are discarded. In another example, the logging string may be searched by regular expression, and sub-strings matching the regular expression may be removed. For example, a line may include the following:

com.sas.solutions.profitability.common.core.operation.ImportTask.-
execute(ImportTask.java:143)

Using regular expression “\(*\)*” the characters between the “(” and the “)” inclusively may be removed leaving the following line:

com.sas.solutions.profitability.common.core.operation.ImportTask.execute

Alternatively, a similar regular expression may be used to identify and remove the characters between the parentheses while leaving the parentheses as in:

com.sas.solutions.profitability.common.core.operation.ImportTask.execute( )

At block 612, the modified logging string is inputted into a hashing algorithm. In one example, the entire modified logging string may be used as input. In another example, the modified logging string may be truncated or may have string characters added. For example, a hashing algorithm may only accept a string of a particular length. Before inputting the modified logging string into the hashing algorithm, the modified logging string may be truncated to that particular length.

At block 614, a second identifier is received, the second identifier determined by the hashing algorithm. In one example, the hashing algorithm may divide the modified logging string into equal-length subparts. For example, a 32-bit logging string might be divided into 4 separate bytes. The numerical representation of each byte may be determined and the number used as a particular variable in the algorithm. For example, if the first byte consisted of 00000011, then the number “3” (the numerical representation of 00000011) may be used as input for the first variable of the hashing algorithm. In this manner, the other variables may be determined and the algorithm fully executed. The second identifier returned may comprise any suitable alphanumeric identifier of any suitable length.

At block 616, the first identifier and the second identifier are presented. Alternatively, the first identifier and second identifier may be stored for later evaluation. In one example, the first and second identifiers may be displayed alongside the logging string or modified logging string within an output window or log file.

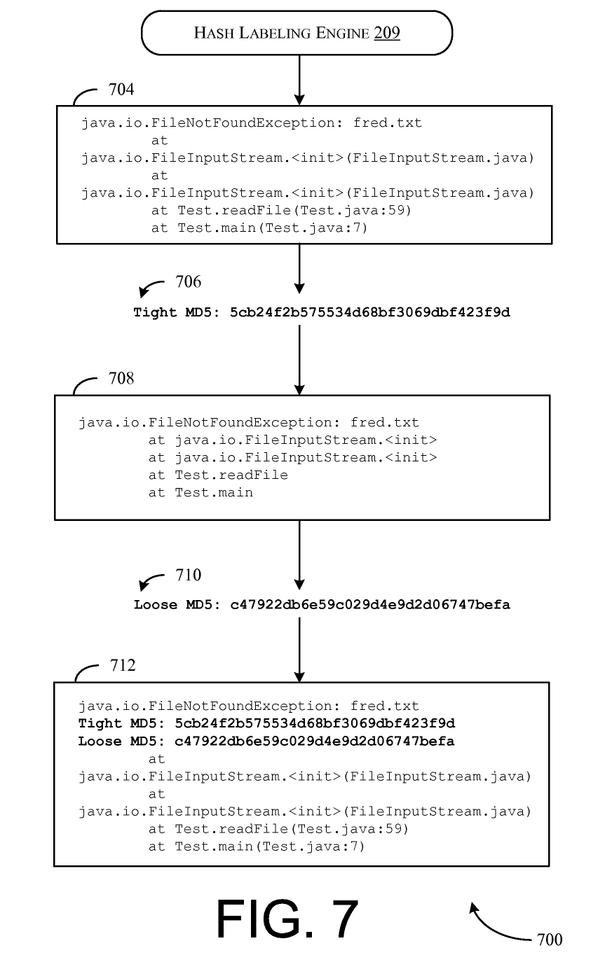

FIG. 7 shows an example process 700 for generating hashing identifiers using an MD5 hashing algorithm. The process begins when hash labeling engine 209 detects an error in program code during program execution. The hash labeling engine 209 may call any suitable function or method to obtain a logging string. For example, a stack trace 704 may be returned as a result of hash labeling engine 209 calling getStackTrace( ) in Java™. Stack trace 704 may be used as input into one or more hashing algorithms, for example, as input into a MD5 hashing algorithm.

At 706, a “tight” alphanumeric identifier is determined such as the one depicted in FIG. 7. For example, the tight alphanumeric identifier may be a hashing checksum returned from the hashing algorithm when the stack trace 704 is used as input.

Hash labeling engine 209 removes a portion of the stack trace to determine a modified stack trace 708. The modified stack trace 708 may be similar to stack trace 704 except that modified stack trace 708 may have one or more filenames or one or more line numbers removed as compared to stack trace 704.

At 710, a “loose” alphanumeric identifier is determined such as the one depicted in FIG. 7. For example, the tight alphanumeric identifier may be a hashing checksum returned from the hashing algorithm when the modified stack trace 708 is used as input. Though, in this example, the tight alphanumeric identifier is determined prior to the loose alphanumeric identifier, any order of determination may occur. In some cases, the loose alphanumeric identifier may be determined prior to the tight alphanumeric identifier.

Hash labeling engine 209 presents one or both identifiers to the user. For example, logging output 712 may be used to present stack trace 704 along with both the tight and loose alphanumeric identifiers. Additionally, or alternatively, hash labeling engine 209 may cause one or both identifiers to be stored in a database. The user may input descriptive information corresponding to one or both of the identifiers. For instance, the user might describe the problem and associate the problem description with one or both of the hash identifiers. In another example, the user might describe a problem resolution and associate the resolution description with one or both of the hash identifiers. The user may use the identifiers for future searches against an error database in order to ascertain information related of errors matching stack trace 704. For example, the tight alphanumeric identifier and loose alphanumeric identifier may be used to query a database storing previously experienced errors. The database could contain information related to an error, using either or both of the alphanumeric identifiers as keys. For instance, the tight alphanumeric identifier may be used to query an error database in order to return results indicating a resolution to the error corresponding to the tight alphanumeric identifier. In one example, the resolution description could instruct the user to upgrade to a particular version of software in order to resolve the error.

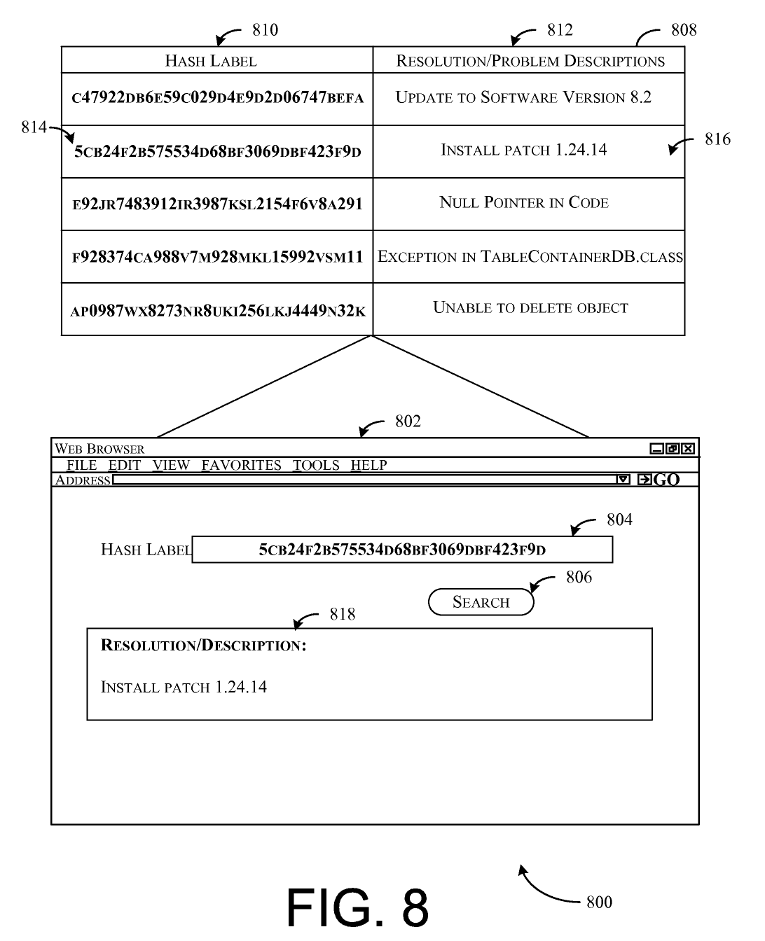

FIG. 8 shows an example environment 800 for searching an error database utilizing a hash identifier. A user can utilize a web browser 802, for example, to input a search string 804 corresponding to a hash label identifier. Though web browser 802 is used as an example, any search interface may be utilized. Once search string 804 is entered, the user may submit the search by selecting search button 806. Search string 804 may be used as input in a database query that is used to return results from database 808. Database 808 can store relationships between hash labels 810 and resolution/problem descriptions 812. For instance, search string 804 may correspond to hash label 814. A query submitted to database 808 using search string 804, returns resolution/problem description 816. Resolution/problem description 816 may be displayed to the user via web browser 802 for example at text box 818. Database 808 is used for illustrative purposes, it would be apparent to those skilled in the art that any database, hash table, or other storage container capable of storing relationships between hash identifiers and resolution and/or problem descriptions may be utilized.

Systems and methods according to some examples may include data transmissions conveyed via networks (e.g., local area network, wide area network, Internet, or combinations thereof, etc.), fiber optic medium, carrier waves, wireless networks, etc. for communication with one or more data processing devices. The data transmissions can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, removable memory, flat files, temporary memory, databases, programming data structures, programming variables, IF-THEN (or similar type) statement constructs, etc.). It is noted that data structures may describe formats for use in organizing and storing data in databases, programs, memory, or other computer-readable media for use by a computer program.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows and figures described and shown in this specification can be performed by one or more programmable processors executing one or more computer programs to perform functions by operating on input data and generating output.

Generally, a computer can also include, or be operatively coupled to receive, data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a tablet, a mobile viewing device, a mobile audio player, a Global Positioning System (GPS) receiver, to name just a few. Computer-readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The computer components, software modules, functions, data stores and data structures described herein may be connected directly or indirectly to each other in order to allow the flow of data needed for their operations. It is also noted that a module or processor includes, but is not limited to, a unit of code that performs a software operation, and can be implemented, for example, as a subroutine unit of code, or as a software function unit of code, or as an object (as in an object-oriented paradigm), or as an applet, or in a computer script language, or as another type of computer code. The software components or functionality may be located on a single computer or distributed across multiple computers depending upon the situation at hand.

The computer may include a programmable machine that performs high-speed processing of numbers, as well as of text, graphics, symbols, and sound. The computer can process, generate, or transform data. The computer includes a central processing unit that interprets and executes instructions; input devices, such as a keyboard, keypad, or a mouse, through which data and commands enter the computer; memory that enables the computer to store programs and data; and output devices, such as printers and display screens, that show the results after the computer has processed, generated, or transformed data.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated, processed communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a graphical system, a database management system, an operating system, or a combination of one or more of them.

While this disclosure may contain many specifics, these should not be construed as limitations on the scope or of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be useful. Moreover, the separation of various system components in the implementations described above should not be understood as requiring such separation in all implementations, and it should be understood that the described program components and systems can generally be integrated together in a single software or hardware product or packaged into multiple software or hardware products.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

What is claimed is:

1. A computer-program product tangibly embodied in a non-transitory machine-readable storage medium, including instructions configured to cause a data processing apparatus to:
obtain a logging string that includes a block of output text determined during execution of program code;
generate, by a computing device, a first alphanumeric identifier for the logging string using a hashing algorithm;
remove a portion of the logging string to determine a modified string;
generate, by the computing device, a second alphanumeric identifier for the modified string using the hashing algorithm; and
present the first alphanumeric identifier and the second alphanumeric identifier with the logging string.

2. The non-transitory machine-readable storage medium of claim 1, wherein the instructions for removing the portion of the logging string include further instructions to cause the data processing apparatus to:
identify at least one file name and line number of the logging string; and
remove the at least one file name and line number from the logging string.

3. The non-transitory machine-readable storage medium of claim 1, wherein the instructions for removing the portion of the logging string include further instructions to cause the data processing apparatus to:
obtain predefined regular expressions; and
remove substrings of the logging string, the substrings corresponding to the predefined regular expressions.

4. The non-transitory machine-readable storage medium of claim 1, wherein the logging string is a stack trace identifying at least one function call identifier, at least one file name, and at least one line number contained in the program code.

5. The non-transitory machine-readable storage medium of claim 4, wherein the modified string includes the at least one function call identifier from the stack trace.

6. The non-transitory machine-readable storage medium of claim 1, wherein obtaining the logging string is a result of error handling during execution of program code.

7. The non-transitory machine-readable storage medium of claim 1, wherein the hashing algorithm comprises one of a MD5 algorithm, a SHA-1 algorithm, a SHA-2 algorithm, or a SHA-3 algorithm.

8. The non-transitory machine-readable storage medium of claim 1, wherein the instructions for generating, by the computing device, the first alphanumeric identifier for the logging string include further instructions to cause the data processing apparatus to:
execute the hashing algorithm using the logging string as input; and
receive the first alphanumeric identifier as a result of the execution of the hashing algorithm.

9. The non-transitory machine-readable storage medium of claim 1, wherein presenting the first alphanumeric identifier and the second alphanumeric identifier with the logging string enables a search to identify the logging string, the search conducted using at least one of the first alphanumeric identifier or the second alphanumeric identifier as an input.

10. The non-transitory machine-readable storage medium of claim 1, wherein presenting the first alphanumeric identifier and the second alphanumeric identifier with the logging string enables a search to identify logging strings having similar function call identifiers as the logging string, the search conducted using at least one of the first alphanumeric identifier or the second alphanumeric identifier as an input.

11. A computer-implemented method, comprising:
obtaining a logging string that includes a block of output text determined during execution of program code;
generating, by a computing device, a first alphanumeric identifier for the logging string using a hashing algorithm;
removing, by the computing device, a portion of the logging string to determine a modified string;
generating, by the computing device, a second alphanumeric identifier for the modified string using the hashing algorithm; and
presenting the first alphanumeric identifier and the second alphanumeric identifier with the logging string.

12. The computer-implemented method of claim 11, wherein removing the portion of the logging string comprises:
identifying at least one file name and line number of the logging string; and
removing the at least one file name and line number from the logging string.

13. The computer-implemented method of claim 11, wherein removing the portion of the logging string comprises:
obtaining predefined regular expressions; and
removing substrings of the logging string, the substrings corresponding to the predefined regular expressions.

14. The computer-implemented method of claim 11, wherein the logging string is a stack trace identifying at least one function call identifier, at least one file name, and at least one line number contained in the program code.

15. The computer-implemented method of claim 14, wherein the modified string includes the at least one function call identifier from the stack trace.

16. The computer-implemented method of claim 11, wherein obtaining the logging string is a result of error handling during execution of the program code.

17. The computer-implemented method of claim 11, wherein the hashing algorithm comprises one of a MD5 algorithm, a SHA-1 algorithm, a SHA-2 algorithm, or a SHA-3 algorithm.

18. The computer-implemented method of claim 11, wherein generating, by the computing device, the first alphanumeric identifier for the logging string comprises:
executing the hashing algorithm using the logging string as input; and
receiving the first alphanumeric identifier as a result of the execution of the hashing algorithm.

19. The computer-implemented method of claim 11, wherein presenting the first alphanumeric identifier and the second alphanumeric identifier with the logging string enables a search to identify the logging string, the search conducted using the first alphanumeric identifier or the second alphanumeric identifier as input.

20. The computer-implemented method of claim 11, wherein presenting the first alphanumeric identifier and the second alphanumeric identifier with the logging string enables a search to identify logging strings containing similar function call identifiers as the logging string, the search conducted using the first alphanumeric identifier or the second alphanumeric identifier as input.

21. A system, comprising:
a processor; and
a non-transitory computer-readable storage medium including instructions that when executed by the processor cause the system to perform operations including:
obtaining a logging string that includes a block of output text determined during execution of program code;
generating, by a computing device, a first alphanumeric identifier for the logging string using a hashing algorithm;
removing, by the computing device, a portion of the logging string to determine a modified string;
generating, by the computing device, a second alphanumeric identifier for the modified string using the hashing algorithm; and
presenting the first alphanumeric identifier and the second alphanumeric identifier with the logging string.

22. The system of claim 21, wherein the instructions for removing the portion of the logging string include further instructions that cause the system to perform operations including:
identifying at least one file name and line numbers of the logging string; and
removing the at least one file name and line numbers from the logging string.

23. The system of claim 21, wherein the instructions for removing the portion of the logging string include further instructions that cause the system to perform operations including:
obtaining predefined regular expressions; and
removing substrings of the logging string, the substrings corresponding to the predefined regular expressions.

24. The system of claim 21, wherein the logging string is a stack trace identifying at least one function call identifier, at least one file name, and at least one line number contained in the program code.

25. The system of claim 24, wherein the modified string includes the at least one function call identifier from the stack trace.

26. The system of claim 21, wherein obtaining the logging string is a result of error handling during execution of the program code.

27. The system of claim 21, wherein the hashing algorithm comprises one of a MD5 algorithm, a SHA-1 algorithm, a SHA-2 algorithm, or a SHA-3 algorithm.

28. The system of claim 21, wherein the instructions for generating, by the computing device, the first alphanumeric identifier for the logging string include further instructions that cause the system to perform operations including:
executing the hashing algorithm using the logging string as input; and
receiving the first alphanumeric identifier as a result of the execution of the hashing algorithm.

29. The system of claim 21, wherein presenting the first alphanumeric identifier and the second alphanumeric identifier with the logging string enables a search to identify the logging string, the search conducted using the first alphanumeric identifier or the second alphanumeric identifier as input.

30. The system of claim 21, wherein presenting the first alphanumeric identifier and the second alphanumeric identifier with the logging string enables a search to identify logging strings containing similar function call identifiers as the logging string, the search conducted using the first alphanumeric identifier or the second alphanumeric identifier as input.
